(19) United States
(12) Patent Application Publication
(10) Pub. No.: US 2011/0000167 A1
(43) Pub. Date: Jan. 6, 2011

(54) WOOD DOOR CORE INCLUDING OSB LAYERS AND METHOD

(76) Inventor: ROBERT G. DIMKE, HAM LAKE, MN (US)

Correspondence Address: MERCHANT & GOULD PC, P.O. BOX 2903, MINNEAPOLIS, MN, 55402-0903, US

(21) Appl. No.: 12/498,233

(22) Filed: Jul. 6, 2009

(51) Int. Cl. E04C 2/34; B32B 21/13; B32B 21/14; B32B 38/10; B32B 37/02

(52) U.S. Cl. 52/784.1; 156/154; 428/292.4; 428/119; 52/745.19

(57) ABSTRACT

A construction panel including at least first, second, and third oriented stranded board (OSB) materials in sheet form adhesively glued together in a back to back arrangement. The construction panel can be used as a wood door core. A wood veneer covering or other exterior covering can be placed over the core as desired. The door construction may include rails along the top and the bottom of the core, and stiles along the side of the core. A method of assembling a construction panel wherein three panels of oriented stranded board (OSB) material in sheet form are glued together in a back to back arrangement. In one method, the two outermost faces of the panel are sanded or otherwise processed to smooth out imperfections on the front and rear faces.

### TECHNICAL FIELD

The present invention related to wood door constructions and methods.

### BACKGROUND OF THE INVENTION

Solid wood doors are known and generally have an aesthetically pleasing appearance. Alternatives to solid wood doors were developed to reduce cost. Improvements in door constructions are desired.

### SUMMARY OF THE INVENTION

The present invention relates to a construction panel including at least first, second, and third oriented stranded board (OSB) materials in sheet form which are glued together in a back to back arrangement. In one embodiment, the construction panel can be used as a wood door core. A wood veneer covering or other covering can be placed over the core as desired. The door construction may include rails along the top and the bottom of the core, and stiles along the sides of the core.

The present invention also relates to a method of assembling a construction panel wherein at least three sheets of oriented stranded board (OSB) material are glued together in a back to back arrangement. In one preferred method, one or both of the two outermost faces of the construction panel are sanded or otherwise processed to smooth out imperfections on the outermost faces.

A further method in accordance with the present invention relates to manufacturing a door by providing a door core construction including at least three layers of oriented stranded board (OSB) material in sheet form which are glued together, and then adding stiles and rails to the core. The method further includes adding a veneer wood covering or other covering to the core. The outermost faces of the core including the stiles and rails can be sanded or otherwise smoothed out before the covering is added. Hardware can be added to the door from the top, sides, or front or rear faces.

### BRIEF DESCRIPTION OF THE FIGURES

FIG. 1 is a perspective view of a door incorporating a wood door core including a construction panel made from multiple layers or sheets of oriented stranded board (OSB) material;

FIG. 2 is an exploded schematic cross-sectional view of the wood door core including the construction panel showing the multiple sheets of OSB material before the sheets are glued together;

FIG. 3 is a schematic cross-sectional view of the wood door core including the construction panel made from multiple sheets of OSB material;

FIG. 4 is a schematic cross-sectional view of the door having the core including the construction panel made from multiple sheets of OSB material, showing outermost portions of the panel removed, and a screw inserted into the panel to mount hardware;

FIG. 5 is an end view of an example rail including a portion made from multiple sheets of OSB material;

### DETAILED DESCRIPTION

Oriented stranded board (OSB) materials in sheet form include elongated wood chips throughout the sheet glued together to form the sheet. Such sheets are used in the construction and manufacturing industries. The sheets come in various sizes, such as 4×8 feet. The wood chips in the OSB sheets are typically oriented in an organized manner. OSB sheets are typically less expensive than solid wood. OSB sheets are also less expensive than plywood, which is made up of layers of thin sheets of wood glued together. OSB sheets are available in a variety of thicknesses.

OSB sheets, while having a uniform appearance in general from a front face to a back face through the sheet, actually have stronger outer layers relative to the middle layer. In some instances, the outer layers of the OSB sheets include smaller wood chips and less voids than the middle layer.

One implementation of the invention is to utilize separately made sheets of OSB material, and select desired thicknesses to be adhesively joined to create a desired door core thickness, taking into account that outer portions of the core are removed by thinning the door core during the door construction process. The resulting door core includes multiple original outer layers or portions of the original sheets of OSB material. In one preferred implementation, four original outer portions are included in the final door construction.

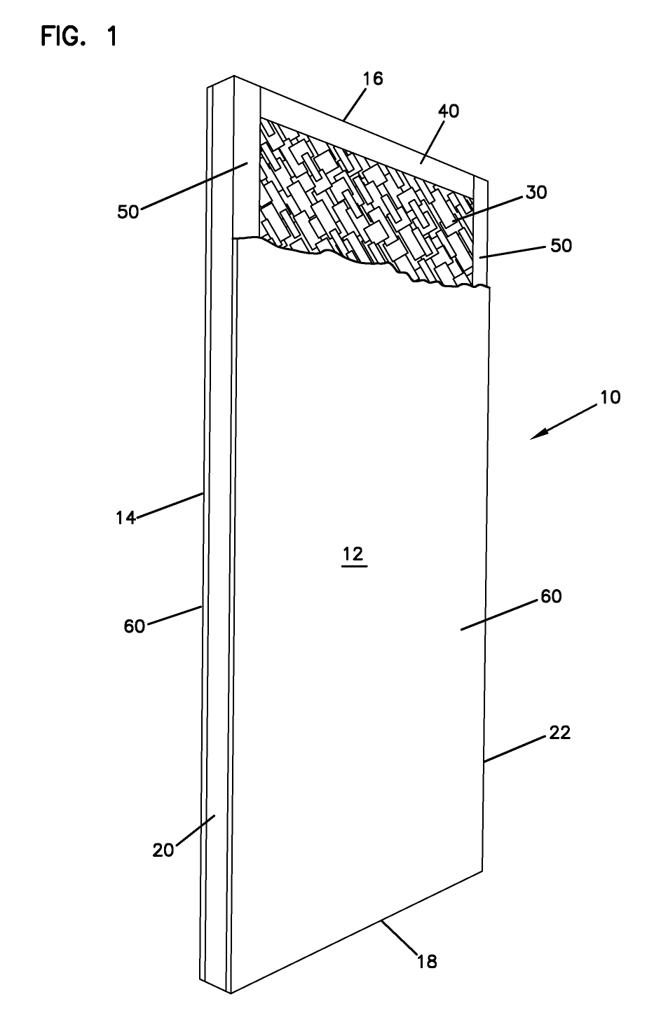

Referring now to FIG. 1, a door 10 in accordance with one embodiment of the invention is shown. Door 10 includes a front 12, and an opposite rear 14. Door 10 includes a top 16, a bottom 18, a first side 20 and a second side 22. Door 10 includes an inner core 30 which is not made from solid wood. Instead, core 30 is a construction panel made from multiple layers of OSB panels or sheets.

Door 10 also includes top and bottom rails 40. Only top rail 40 is shown. Door 10 includes side stiles 50. Both rails 40 and stiles 50 are affixed to core 30. Rails 40 and stiles 50 can be made from conventional materials, such as solid wood (e.g. hardwood such as oak). Alternatively, rails 40 and stiles 50 can be made using multiple layers of OSB panels or sheets. A veneer covering 60 of solid wood is provided to give door 10 a more aesthetically pleasing appearance. Veneer covering 60 can be made from other materials and can be attached with adhesive.

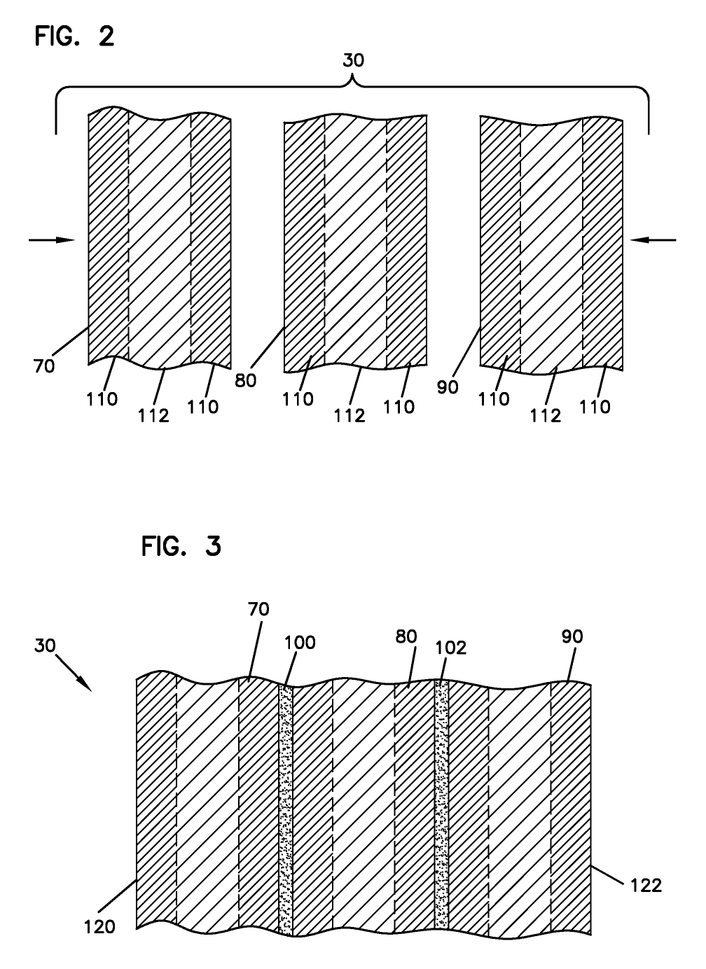

Referring now to FIGS. 2-4, core 30 is shown in greater detail. Core 30 includes at least three sheets of OSB material in a back to back (or face to face) arrangement. Core 30 of FIGS. 2-4 includes a first sheet 70 and a second sheet 80 adhesively joined together with adhesive 100. Second sheet 80 is joined to a third sheet with adhesive 102. It is to be appreciated that the various thicknesses of sheets 70, 80, 90 can be the same or different from each other. In one embodiment, the second sheet 80 is thicker than outer sheets 70, 90. Further, adhesive 100 is preferably the same as adhesive 102, although different adhesives can be used, if desired. Core 30 can be made using various combinations of adhesive, and heat, pressure and time, as desired.

With respect to each separate sheet 70, 80, 90, original outer portions or layers 110 are identified relative to a middle portion or layer 112. As noted above, outer portions 110 of each sheet of OSB material are typically stronger than middle portions 112 in its form as manufactured. Note that the dashed lines are approximate and that there is often not a clear delineation between the stronger outer portions 110 and the weaker middle portions 112.

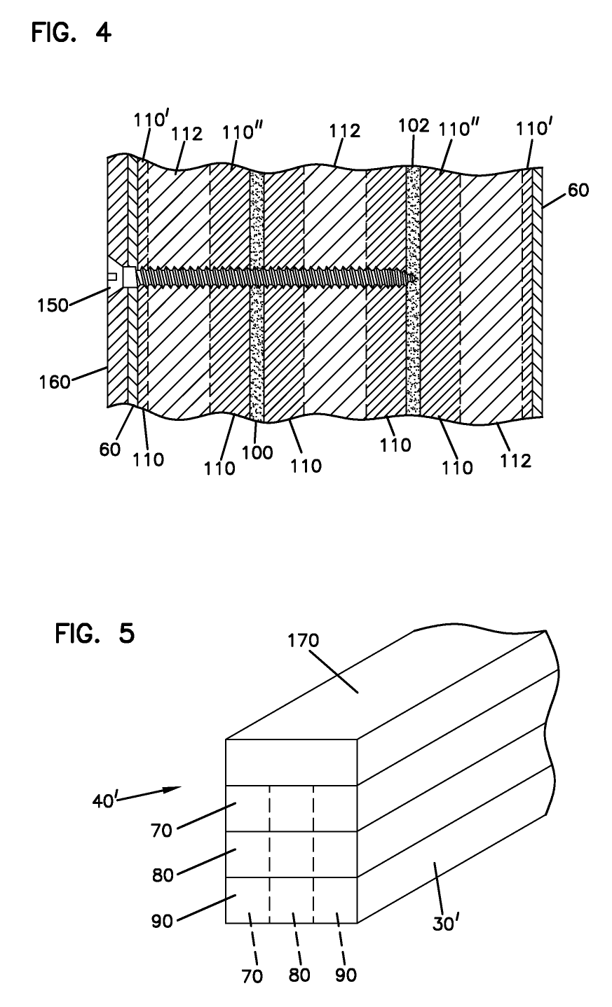

In some door constructions, the outer faces 120, 122 of core 30 are sanded or otherwise removed before veneer wood covering 60 is applied. Compare FIGS. 2 and 3 with FIG. 4 where outermost portions at faces 120 and 122 have been sanded down. Therefore, if outer faces 120, 122 of core 30 are removed or thinned down by sanding, some of the stronger outer portions of the OSB sheets of core 30 have been removed. Note the thinner outer portions 110′ in FIG. 4, relative to original outer portions 110″. However, core 30 still has four original outer portions 110 contained within core 30 for structural integrity.

In one example, core 30 is made as follows: first and third sheets of OSB material 70, 90 at 7/16 inches thick; second sheet of OSB material 80 at 23/32 inches thick; adhesives 100, 102 are the same PVA material. A press can be used to hold core 30 together during curing of the adhesive. Core 30 is then sanded to a thickness of 1 and ½ inches. Door 10 then has up to four original outer portions 110 of OSB material for strength and/or holding mounting hardware (screws). FIG. 4 shows hardware 160 mounted to door 10 with a screw 150. Hardware 160 can include door closers, door knobs, panic bars, windows, and hinges, for example.

Door 10 with core 30 is designed to meet various industry standards for Window & Door Manufacturers Association (WDMA) including: Screwholding WDMA TM-10, 1990 of 330 pounds horizontal door edge and 550 pounds vertical door edge; and Cycle Slam WDMA TM-8, 1990 of 1,000,000 cycles, for Extra Heavy Duty performance.

Referring now to FIG. 5, an example alternative rail 40′ is shown in end view using a first wood piece or strip 170 of solid wood (e.g., oak), mounted to a strip 30′ of the multiple layers of OSB material as in door core 30. The layers of OSB within strip 30′ can be parallel to strip 170, or in the cross direction. Note that in the illustrated embodiment, strip 170 is thinner in height than it is in width. Strip 170 and strip 30′ typically extend as long as the length or height of the core 30 it is mounted to. Hardware 160 can be mounted to rail 40′ as desired. Stiles 50 can be constructed in a similar manner.

In some embodiments, core 30 and strip 30′ can include more than three layers of OSB material, such as four or more.

What is claimed is:

1. A door construction comprising:
a) a body including a core including:
i) a first sheet of OSB material including a first major side and a second major side opposite the first major side;
ii) a second sheet of OSB material including a first major side and a second major side opposite the first major side;
iii) a third sheet of OSB material including a first major side and a second major side opposite the first side;
iv) a first adhesive material between the second major side of the first sheet and the first major side of the second sheet; and
v) a second adhesive material between the second major side of the second sheet and the first major side of the third sheet;
b) the body including top and bottom rails affixed to the core;
c) the body including first and second stiles affixed to the core;
d) a first covering on a first major side of the body; and
e) a second covering on a second major side of the body opposite the first major side.

2. The door construction of claim 1, wherein at least one of the rails includes:
a strip of solid wood;
a multi-layer backing including at least three layers of OSB material adhesively joined together.

3. The door construction of claim 1, wherein at least one of the stiles includes:
a strip of solid wood;
a multi-layer backing including at least three layers of OSB material adhesively joined together.

4. A method of assembling a construction panel comprising:
providing:
a first sheet of OSB material including a first major side and a second major side opposite the first major side;
a second sheet of OSB material including a first major side and a second major side opposite the first major side;
a third sheet of OSB material including a first major side and a second major side opposite the first side;
placing a first adhesive material between the second major side of the first sheet and the first major side of the second sheet;
placing a second adhesive material between the second major side of the second sheet and the first major side of the third sheet;
wherein the first, second and third sheets are separately formed before the first, second, and third sheets are adhesively joined;
smoothing out the first and third sheets, wherein portions of the first major side of the first sheet and portions of the second major side of the third sheet are removed so as to expose inner portions not visible when the first, second, and third sheets are adhesively joined.

5. The method of claim 4, wherein the second sheet is thicker than the first sheet before the smoothing out step, and wherein the second sheet is thicker than third sheet before the smoothing out step.

6. A door construction comprising:
a) a core including:
i) a first sheet of OSB material including a first major side and a second major side opposite the first major side;
ii) a second sheet of OSB material including a first major side and a second major side opposite the first major side;
iii) a third sheet of OSB material including a first major side and a second major side opposite the first side;
iv) a first adhesive material between the second major side of the first sheet and the first major side of the second sheet;
v) a second adhesive material between the second major side of the second OSB sheet and the first major side of the third sheet;
b) top and bottom rails affixed to the core and having first and second faces parallel to the first and second major sides of the first, second, and third sheets; and
c) first and second stiles affixed to the core and having first and second faces parallel to the first and second major sides of the first, second, and third sheets;
wherein the first major side of the first sheet and the second major side of the third sheet are provided with a smoothed surface where portions are removed;
wherein the first and second faces of the rails and the first and second faces of the stiles are provided with smoothed surfaces co-planar with the first major side of the first sheet, and co-planar with the second major side of the second sheet, respectively, where portions are removed.

7. A method of constructing a door comprising:
providing a core including at least three sheets of OSB material, each sheet including a first major side and a second major side opposite the first major side and, an adhesive material between the major sides of the OSB sheets to form a multiple layer panel;
affixing vertical stiles and horizontal rails around a periphery of the at least three sheets of OSB material to form an inner door;
removing a portion of a first major surface of the inner door;
removing a portion of a second major surface of the inner door facing opposite to the first major surface;
affixing a first covering to a front of the inner door;
affixing a second covering to a rear of the inner door.

8. A method of constructing a door comprising:
providing at least three OSB panels in a face to face orientation;
gluing the faces of the OSB panels together;
removing portions of the front and rear faces of the glued together panels to smooth out the front and rear faces;
adding a covering to each of the smoothed out front and rear faces to form the door;
mounting hardware to an exterior of the door wherein at least one fastener penetrates and passes completely through at least two of the OSB panels.

9. A door component for affixing to a door core comprising:
a strip of solid wood;
a multi-layer backing including at least three layers of OSB material adhesively joined together.

10. The door component of claim 9, wherein the layers of OSB material are perpendicular to the strip of solid wood.

11. The door component of claim 9, wherein the layers of OSB material are parallel to the strip of solid wood.
